(19) United States
(12) Patent Application Publication
(10) Pub. No.: US 2008/0061995 A1
(43) Pub. Date: Mar. 13, 2008

(54) Fluid leak alert system

(76) Inventor: Wade William Goodall, Queen Creek, AZ (US)

Correspondence Address: GALASSO & ASSOCIATES, LP, P.O.Box 26503, Austin, TX, 78755-0503, US

(21) Appl. No.: 11/519,581

(22) Filed: Sep. 12, 2006

(51) Int. Cl. G08B 21/00

(52) U.S. Cl. 340/605

(57) ABSTRACT

A fluid leak alert system comprises a flow sensor and a timer apparatus. The flow sensor is configured for sensing presence of fluid flow through a fluid flow line. The timer apparatus is connected to the flow sensor. The timer apparatus compares a prescribed maximum flow interval duration to a length of time over which the presence of fluid flow through the fluid flow line is sensed for determining if the length of time that fluid flow is present is greater than the prescribed maximum flow interval duration. The timer apparatus outputs an alert signal when the length of time is greater than the prescribed maximum flow interval duration. The timer apparatus includes a flow interval duration adjuster for enabling the prescribed maximum flow interval duration to be selectively set to any one of a plurality of different prescribed maximum flow interval durations.

### FIELD OF THE DISCLOSURE

The disclosures made herein relate generally to fluid flow metering and monitoring systems and, more particularly, to fluid leak alert systems.

### BACKGROUND

Building structures, whether residential, commercial, industrial or otherwise, generally have a plumbing system that includes pressurized fluid flow lines (e.g., water supply lines). These pressurized fluid flow lines are routed through walls, within floors, through basement areas, in overhead spaces and/or through attic spaces of such building structures. Such fluid flow lines supply fluid to apparatuses such as, for example, industrial processing equipment, household appliances, faucets, toilets and the like.

When a leak develops in a fluid flow line, it can go unnoticed for a long period of time due to the fluid flow line often being in a concealed location. Left unaddressed for enough time, a fluid leak can result in floors, walls equipment, etc being damaged, structural supports being damaged, growth of hazardous mold, etc. Due to the pressurization of some fluid flow lines, large volumes of fluid can be leaked in a relatively short period of time. The combination of potentially a large volume of fluid being leaked in a relatively short period of time and the leaked fluid being concealed for at least a portion of time during the leak can result in significant wasting of such fluid, significant damage to a building structure and/or significant damage to items and equipment within a building structure.

Therefore, a system that provides an alert of a leak in a fluid flow line is useful.

### SUMMARY OF THE DISCLOSURE

The present invention provides for a novel, advantageous and useful approach for determining when a leak is present in a fluid flow line and provide for an alert of such a leak condition in response to determining such a leak condition exists. Embodiments of the present invention and their implementation are useful and applicable in all types of residential, commercial and industrial building structures. Through implementation of embodiment of the present invention, the risk of major loss due to leaking fluid flow lines is greatly reduced.

In one embodiment of the present invention, a method for detecting unintentional flow of fluid through a fluid flow line comprises a plurality of operations. An operation is performed for determining a length of time that fluid flow is present within a fluid flow line, an operation is performed for comparing the length of time that fluid flow is present to a prescribed maximum flow interval duration and an operation is performed for outputting an alert in response to determining that the length of time that fluid flow is present is greater than the prescribed maximum flow interval duration.

In another embodiment of the present invention, a fluid leak alert system comprises a flow sensor and a timer apparatus. The flow sensor is configured for sensing presence of fluid flow through a fluid flow line. The timer apparatus is connected to the flow sensor. The timer apparatus compares a prescribed maximum flow interval duration to a length of time over which the presence of fluid flow through the fluid flow line is sensed for determining if the length of time that fluid flow is present is greater than the prescribed maximum flow interval duration. The timer apparatus outputs an alert signal when the length of time is greater than the prescribed maximum flow interval duration.

In another embodiment of the present invention, a fluid leak alert system comprises a flow sensing unit and a timer unit. The flow sensing unit includes a body and a flow sensor connected to the body. The body is configured for being connected in series with a fluid flow line for enabling fluid from the fluid flow line to flow through the body. The flow sensor is configured for sensing presence of fluid flow through the body. The timer unit is connected to the flow sensing unit. The timer unit compares a prescribed maximum flow interval duration to a length of time over which said presence of fluid flow through the fluid flow line is sensed for determining if the length of time that fluid flow is present is greater than the prescribed maximum flow interval duration. The timer unit includes an audible output device that outputs an audible alert when the length of time is greater than the prescribed maximum flow interval duration.

Turning now to specific aspects of the present invention, in at least one embodiment, a fluid leak alert system includes a flow interval duration adjuster for enabling the prescribed maximum flow interval duration to be selectively set to any one of a plurality of different prescribed maximum flow interval durations.

In at least one embodiment of the present invention, an audible output device is provides an alert signal to an audible output device for causing the audible output device to output an audible alert.

In at least one embodiment of the present invention, a network interface device is provided for enabling a pre-configured alert message to be transmitted over a network connection for reception by a designated recipient.

In at least one embodiment of the present invention, a flow shut-off valve provides a signal to a flow shut-off valve after determining that a length of time that fluid flow is present is greater than a prescribed maximum flow interval duration and the signal causes the flow shut-off valve to move from a flow-enabled configuration to a flow-disabled configuration.

In at least one embodiment of the present invention, determining a length of time that fluid flow is present includes determining a length of time that a signal is received from a fluid flow sensor.

In at least one embodiment of the present invention, outputting the alert includes at least one of outputting an audible art, transmitting an alert notification message over a network connection and outputting an alert signal.

In at least one embodiment of the present invention, determining a length of time that fluid flow is present includes receiving a signal corresponding to the length of time that the fluid flow is present.

In at least one embodiment of the present invention, comparing a length of time that fluid flow is present to a prescribed maximum flow interval duration includes determining if the signal corresponds to a length of time that exceeds the prescribed maximum flow interval duration.

In at least one embodiment of the present invention, an operation is provided for outputting a signal to a flow shut-off valve for causing the flow shut-off valve to move from a flow-enabled configuration to a flow-disabled configuration after determining that the length of time that fluid flow is present is greater than the prescribed maximum flow interval duration.

In at least one embodiment of the present invention, outputting the signal to the flow shut-off valve is performed after a prescribed period of time has elapsed since the operation of outputting the alert is performed.

In at least one embodiment of the present invention, determining that the length of time that fluid flow is present within the fluid flow line includes sensing stoppage of the fluid flow during a current instance of determining that the length of time that fluid flow is present and initiating a new instance of determining the length of time that fluid flow is present after the stoppage of fluid flow is sensed during the current instance of determining that the length of time that fluid flow is present.

These and other objects, embodiments, advantages and/or distinctions of the present invention will become readily apparent upon further review of the following specification, associated drawings and appended claims.

### BRIEF DESCRIPTION OF THE DRAWINGS

FIG. 1 is a flow chart showing an embodiment of a method for detecting unintentional fluid flow in accordance with the present invention.

FIG. 2 is a block diagram showing a conceptual embodiment of a fluid leak alert system in accordance with the present invention.

FIG. 3 is a perspective view showing a specific embodiment of a fluid leak alert system in accordance with the present invention.

FIG. 4 is a cross-sectional view taken along the line 4-4 in FIG. 3.

### DETAILED DESCRIPTION OF THE DRAWING FIGURES

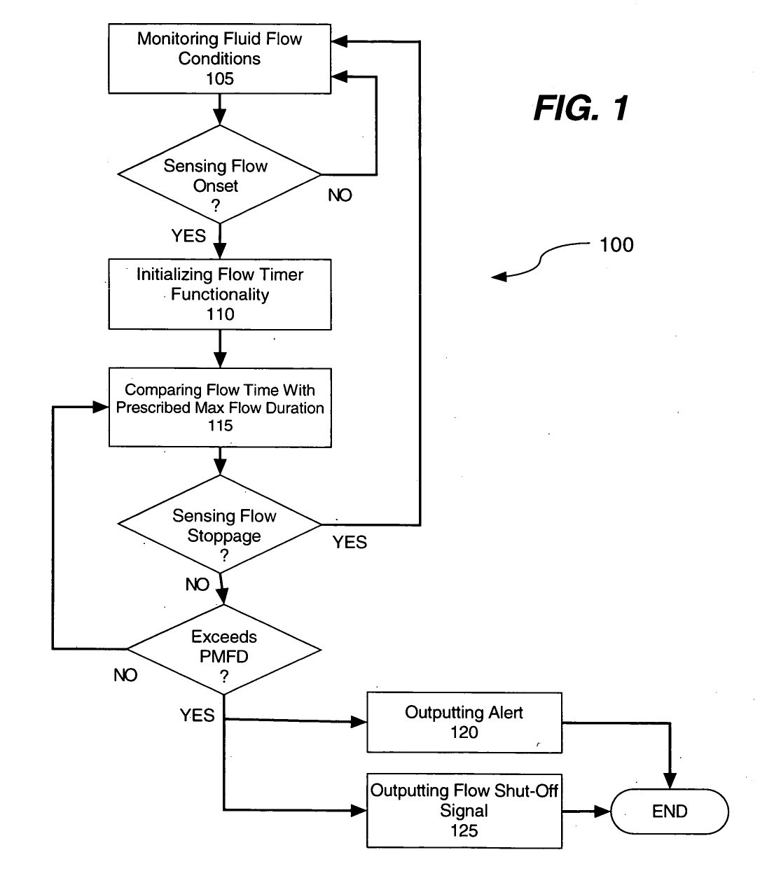

FIG. 1 shows an embodiment of a method for detecting unintentional fluid flow through a fluid flow line, which is referred to herein as the method 100. The method 100 is configured for providing flow detection functionality in accordance with the present invention. One example of the usefulness of such flow detection functionality is detecting a leak in a fluid flow line such as a water supply pipe.

The method 100 includes an operation 105 for monitoring for flow conditions of a fluid within a fluid flow line. For example, a flow sensor is provided in or on a fluid flow line. The flow sensor provides a signal corresponding fluid beginning to flow through the fluid flow line and provides a signal corresponding to stoppage of fluid flow through the fluid flow line. In response to sensing the onset of fluid flow, an operation 110 is performed for initializing flow timer functionality. One example of initializing flow timer functionality for a resettable flow timer includes resetting the flow timer to an initial setting (e.g., zeroing) and starting the flow timer, thereby providing a flow time starting value. One example of initializing flow timer functionality for a continually counting flow timer includes recording a current counter value, thereby providing a flow time starting value.

After initializing flow timer functionality, an operation 115 is performed for comparing a present fluid flow duration to a prescribed maximum flow duration for determining if the present fluid flow duration exceeds the prescribed maximum flow duration. If so, it is assumed that the fluid flow is unintentional (e.g., a leak). In one embodiment, a signal corresponding to the length of time that fluid flow is present is received and, if it is determined that the signal corresponds to a length of time that exceeds the prescribed maximum flow interval duration, then it is assumed that the fluid flow is unintentional. Broadly, the present fluid flow duration is the number of duration measurement units (e.g., seconds, minutes and/or hours) since the flow time starting value was determined. In one specific example, the present fluid flow duration is the length of time that fluid flow is present within the fluid flow line.

If monitoring of fluid flow conditions does not sense stoppage of fluid flow and if the present fluid flow duration is greater than the prescribed maximum flow duration, an operation 120 is performed for outputting an alert and an operation 125 is performed for outputting a flow shut-off signal. The fluid flow signal is outputted for the purpose of causing a flow shut-off valve to move from a flow-enabled configuration to a flow-disabled configuration. In one embodiment, outputting a flow shut-off signal is performed after a prescribed period of duration has elapsed since the alert signal has been outputted. Such a delay in outputting the flow shut-off signal provides time for completion of critical tasks in the event that the shut-off occurrence is a fault.

If monitoring of fluid flow conditions senses stoppage of fluid flow, the method 100 restarts itself at the operation 105 for the purpose of initiating a new instance of detecting unintentional fluid flow through a fluid flow line. If the present fluid flow duration is not greater than the prescribed maximum flow duration, the method continues at the operation 115 for comparing the present fluid flow duration to a prescribed maximum flow duration. Examples of outputting the alert include, but are not limited to outputting an audible art (e.g., alert noise from a speaker), transmitting an alert notification message over a network connection to a recipient and outputting an alert signal which is used for providing some type of alert notification.

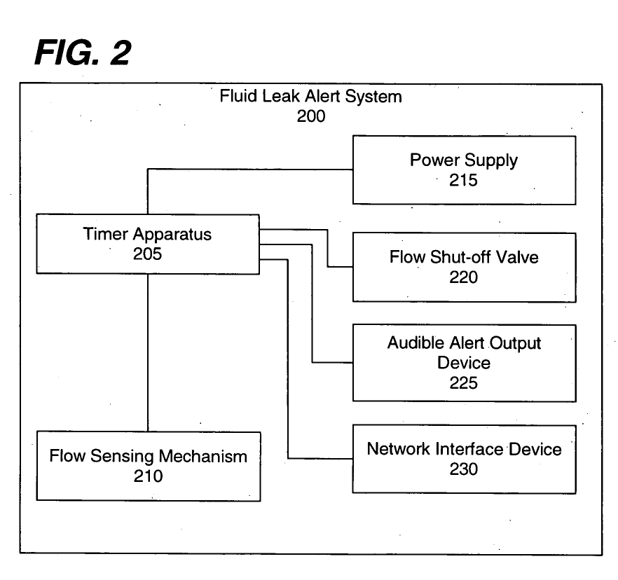

FIG. 2 is a block diagram showing a conceptual embodiment of a fluid leak alert system in accordance with the present invention, which is referred to herein as the fluid leak alert system 200. The fluid leak alert system 200 includes a timer apparatus 205, a flow sensor 210, a power supply 215, a flow shut-off valve 220, an audible alert output device 225 and a network interface device 230. The flow sensor 210, the power supply 215, the flow shut-off valve 220, the audible alert output device 225 and the network interface device 230 are connected to the timer apparatus 205, thereby enabling interoperability between the timer apparatus 205, the flow sensor 210, the power supply 215, the flow shut-off valve 220, the audible alert output device 225 and the network interface device 230.

The flow sensor 210 is configured for sensing presence of fluid flow through a fluid flow line. The power supply 215 (e.g., a battery, an AC-DC power converter, a line outlet plug, etc) is electrically connected to the timer apparatus 205 for providing electrical power to the timer apparatus 205. The timer apparatus 205 receives a signal from the flow sensor 210 and uses that signal to determine if fluid flow is present in a fluid flow line. If it is determined that fluid flow is present in the fluid flow line, the timer apparatus 205 uses the fluid flow signal to determine if the flow is unintentional (i.e., flow is present for longer than a prescribed maximum flow duration). If it is determined that the flow is unintentional, the timer apparatus 205 interacts with the flow shut-off valve 220, the audible alert output device 225 and the network interface device 230 for acting on such unintentional fluid flow. The timer apparatus 205 provides a flow shut-off signal to the flow shut-off valve 220 after determining that the fluid flow is unintentional. The flow shut-off signal causes the flow shut-off valve to move from a flow-enabled configuration to a flow-disabled configuration, thereby inhibiting such unintentional fluid flow through the fluid flow line. The timer apparatus 205 provides an alert signal to the audible output device 225 (e.g., a speaker, buzzer, etc) for causing the audible output device 225 to output an audible alert. The timer apparatus 205 provides an alert message signal to the network interface device 230 whereby a pre-configured alert message is transmitted over a network connection for reception by a designated recipient.

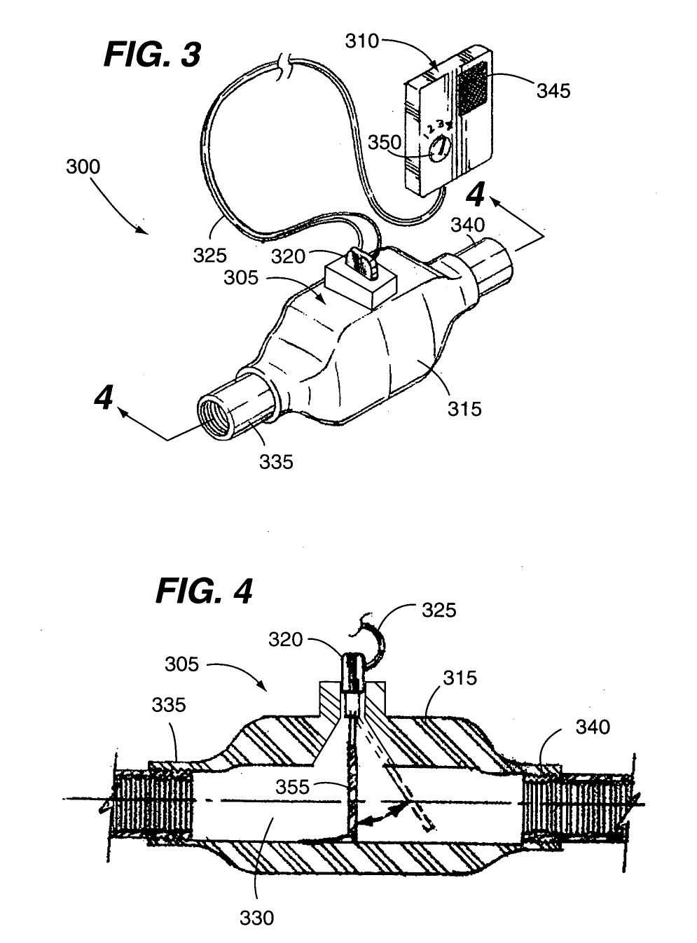

FIGS. 3 and 4 show a specific embodiment of a fluid leak alert system in accordance with the present invention, which is referred to herein as the fluid leak alert system 300. The fluid leak alert system 300 includes a flow sensing unit 305 and timer unit 310. The flow sensing unit 305 includes a body 315 and a flow sensor 320 connected to the body 315. The flow sensor 320 is electrically connected to the timer unit 310 by a cable 325. The body 315 includes a passage 330 (FIG. 4) having an inlet portion 335 and an outlet portion 340 thereby enabling the body 315 to be connected in series with a fluid flow line for enabling fluid from the fluid flow line, to flow through the body 315. The flow sensing unit 305 is configured for sensing presence of fluid flow through the body 310. The timer unit 310 compares a prescribed maximum flow interval duration to a length of time over which said presence of fluid flow through the fluid flow line is sensed for determining if the length of time that fluid flow is present is greater than the prescribed maximum flow interval duration. The timer unit 310 outputs an alert signal when the length of time is greater than the prescribed maximum flow interval duration. The timer unit 310 includes an audible output device 345. The alert signal is provided to the audible output device 345 for causing the audible output device 345 to output an audible alert. The timer unit 310 includes a flow interval duration adjuster 350 for enabling the prescribed maximum flow interval duration to be selectively set to any one of a plurality of different prescribed maximum flow interval durations. The usefulness of the flow interval duration adjuster 350 is that it enables different operational considerations to be accounted for in specifying the prescribed maximum flow interval duration. For example, a household with 5 residents may require a longer prescribed maximum flow interval durations than a household with 2 residents. Power may be provided to the a flow sensing unit 305 and/or timer unit 310 by any number of know means (e.g., battery, AC-DC converter, AC line voltage plug, etc).

It is disclosed herein that any number of different types of flow sensors may be utilized in implementing the present invention. For example, as depicted in FIG. 4, the flow sensor may be of a mechanical type that includes a sensing element portion 355 that physically senses force generated by the flow of fluid. Alternatively, a non-contact type of flow sensor (e.g., capacitive, inductive, etc) may be used. Accordingly, it is disclosed herein that the present invention is not unnecessarily limited to any particular type of flow sensor.

In the preceding detailed description, reference has been made to the accompanying drawings that form a part hereof, and in which are shown by way of illustration specific embodiments in which the present invention may be practiced. These embodiments, and certain variants thereof, have been described in sufficient detail to enable those skilled in the art to practice embodiments of the present invention. It is to be understood that other suitable embodiments may be utilized and that logical, mechanical, chemical and electrical changes may be made without departing from the spirit or scope of such inventive disclosures. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A method for detecting unintentional flow of fluid through a fluid flow line, comprising:
determining a length of time that fluid flow is present within a fluid flow line;
comparing the length of time that fluid flow is present to a prescribed maximum flow interval duration; and
outputting an alert in response to determining that the length of time that fluid flow is present is greater than the prescribed maximum flow interval duration.

2. The method of claim 1 wherein determining the length of time that fluid flow is present includes determining a length of time that a signal is received from a fluid flow sensor.

3. The method of claim 1 wherein outputting the alert includes at least one of outputting an audible art, transmitting an alert notification message over a network connection and outputting an alert signal.

4. The method of claim 1 wherein:
determining the length of time that fluid flow is present includes receiving a signal corresponding to the length of time that said fluid flow is present; and
comparing the length of time that fluid flow is present to a prescribed maximum flow interval duration includes determining if the signal corresponds to a length of time that exceeds the prescribed maximum flow interval duration.

5. The method of claim 1, further comprising:
outputting a signal to a flow shut-off valve for causing the flow shut-off valve to move from a flow-enabled configuration to a flow-disabled configuration after determining that the length of time that fluid flow is present is greater than the prescribed maximum flow interval duration.

6. The method of claim 5 wherein outputting the signal to the flow shut-off valve is performed after a prescribed period of time has elapsed since said outputting the alert is performed.

7. The method of claim 1 wherein determining that the length of time that fluid flow is present within the fluid flow line includes:
sensing stoppage of said fluid flow during a current instance of determining that the length of time that fluid flow is present; and
initiating a new instance of determining the length of time that fluid flow is present after said stoppage of fluid flow is sensed during the current instance of determining that the length of time that fluid flow is present.

8. The method of claim 7 wherein:
determining the length of time that fluid flow is present includes receiving a signal corresponding to the length of time that said fluid flow is present; and
comparing the length of time that fluid flow is present to a prescribed maximum flow interval duration includes determining if the signal corresponds to a length of time that exceeds the prescribed maximum flow interval duration.

9. The method of claim 8, further comprising:
outputting a signal to a flow shut-off valve for causing the flow shut-off valve to move from a flow-enabled configuration to a flow-disabled configuration, wherein outputting the signal to the flow shut-off valve is performed after a prescribed period of time has elapsed since said outputting the alert is performed.

10. A fluid leak alert system, comprising:
a flow sensor configured for sensing presence of fluid flow through a fluid flow line; and
a timer apparatus connected to the flow sensor, wherein the timer apparatus compares a prescribed maximum flow interval duration to a length of time over which said presence of fluid flow through the fluid flow line is sensed for determining if the length of time that fluid flow is present is greater than the prescribed maximum flow interval duration and wherein the timer apparatus outputs an alert signal when the length of time is greater than the prescribed maximum flow interval duration.

11. The fluid leak alert system of claim 10 wherein the timer apparatus includes a flow interval duration adjuster for enabling the prescribed maximum flow interval duration to be selectively set to any one of a plurality of different prescribed maximum flow interval durations.

12. The fluid leak alert system of claim 11, further comprising:
an audible output device connected to the timer apparatus, wherein the alert signal is provided to the audible output device for causing the audible output device to output an audible alert.

13. The fluid leak alert system of claim 12, further comprising:
a network interface device connected to the timer apparatus for enabling a pre-configured alert message to be transmitted over a network connection for reception by a designated recipient.

14. The fluid leak alert system of claim 13, further comprising:
a flow shut-off valve connected to the timer apparatus, wherein timer apparatus provides a signal to the flow shut-off valve after determining that the length of time that fluid flow is present is greater than the prescribed maximum flow interval duration and wherein the signal causes the flow shut-off valve to move from a flow-enabled configuration to a flow-disabled configuration.

15. The fluid leak alert system of claim 14 wherein the signal is provided to the flow shut-off valve after a prescribed period of time has elapsed since the alert signal has been outputted.

16. A fluid leak alert system, comprising:
a flow sensing unit including a body and a flow sensor connected to the body, wherein the body is configured for being connected in series with a fluid flow line for enabling fluid from the fluid flow line to flow through the body and wherein the flow sensor is configured for sensing presence of fluid flow through body;
a timer unit connected to the flow sensing unit, wherein the timer unit compares a prescribed maximum flow interval duration to a length of time over which said presence of fluid flow through the fluid flow line is sensed for determining if the length of time that fluid flow is present is greater than the prescribed maximum flow interval duration and wherein the timer unit includes an audible output device that outputs an audible alert when the length of time is greater than the prescribed maximum flow interval duration.

17. The fluid leak alert system of claim 16 wherein the timer unit includes a flow interval duration adjuster for enabling the prescribed maximum flow interval duration to be selectively set to any one of a plurality of different prescribed maximum flow interval durations.
